(19) United States
(12) Patent Application Publication
(10) Pub. No.: US 2006/0271663 A1
(43) Pub. Date: Nov. 30, 2006

(54) A Fault-tolerant Distributed Data Processing System

(76) Inventors: Fabio Barillari, Priolo G. (Siracusa) (IT); Fabio Benedetti, Roma (IT); Xavier Giannakopoulos, Roma (IT); Serena Girardini, Roma (IT); Pietro Guardascione, Napoli (IT); Pietro Lannucci, Roma (IT); Vincenzo Pirrotina, Roma (IT)

Correspondence Address: IBM CORPORATION;INTELLECTUAL PROPERTY LAW, 11400 BURNET ROAD, AUSTIN, TX, 78758, US

(21) Appl. No.: 11/419,026

(22) Filed: May 18, 2006

(30) Foreign Application Priority Data
May 31, 2005 (EP) 05300432.1

(51) Int. Cl. G06F 15/173

(52) U.S. Cl. 709/223

(57) ABSTRACT

A distributed data processing system comprising a plurality of communicating computers including at least one message originator computer and at least one message destination computer, the message originator computer originating messages to be delivered to the message destination computer, at least one manager computer responsible of managing communications between the computers, wherein the manager computer is adapted to receive the messages originated by the originator computer and to dispatch the messages to the message destination computer, and at least one backup computer adapted to take over the role of the manager computer in case of failure thereof, wherein the backup computer is adapted to receive the messages originated by the originator computer and, in case of failure of the manager computer, to dispatch the messages to the message destination computer. A method comprises having the message originator computer, upon originating a generic message, labelling the message by means of a message identifier, the message identifier being adapted to uniquely identify the originated message; having the message destination computer, upon receipt of a generic message, record the respective message identifier in a list of identifiers of received messages; in case the backup computer takes over the role of the manager computer, having the backup computer retrieve, from the message destination computer, the list of identifiers of received messages; and based on the retrieved list of identifiers of received messages, having the backup computer dispatch to the destination computer messages directed thereto that have been received by the backup computer but not received by the destination computer.

### TECHNICAL FIELD

The present invention relates to the field of data processing systems, particularly of the distributed type, such as computer networks. More specifically, the present invention relates to a fault-tolerant distributed data processing system.

### BACKGROUND ART

Computer networks are made up of several data processing apparatuses (computers, workstations, peripherals, storage devices and the like) connected together by a data communications network. Computer networks may vary in size from small networks, like the LANs (Local Area Networks), to very large networks, possibly composed of a several smaller, interconnected networks (this is for example the case of the Internet).

Computers in a computer network communicates with each other by exchanging messages, whose format depends on the protocol/suite of protocols adopted.

From a logical architecture viewpoint, a computer network may be subdivided in several groups of computers, or network nodes, called “network domains”; computers in a same network domain are logically associated with one another, being for example administered as a common unit with common rules and procedures. A domain manager computer or node typically manages the network domain: for example, all communications to and from the other computers in the domain, particularly messages received from, or directed to (the domain managers of) other domains of the network may have to be routed through the domain manager of that domain. The network domains may be structured hierarchically: for example, a generic network domain may include one or more subordinate domains; each subordinate domain is managed by a respective domain manager computer which is subordinated to the domain manager computer managing the upper-level domain.

By way of example, the commercially-available workload scheduling products suite known under the name “Tivoli Workload Scheduler” by IBM Corporation treats a computer network, for example the production environment of, e.g., a company or a government agency, as a workload scheduler network containing at least one workload scheduler domain, the so-called “master domain”; the master domain manager computer forms the management hub. The workload scheduler network may be structured so as to contain a single domain, represented by the master domain, or as a multi-domain network: in the former case, the master domain manager maintains communications with all the computers of the network; in the multi-domain case, the master domain is the topmost domain of a hierarchical tree of domains: the master domain manager communicates with the computers in its domain, and with subordinate domain manager computers, which manage the subordinate domains. The subordinate domain managers in turn communicate with the computers in their domains and, possibly, with further subordinate domain managers, and so on.

Structuring the computer network in a plurality of domains is advantageous, because it allows reducing the network traffic: communications between the master domain manager and the other computers are in fact reduced in number, because for example the communications between two computers in a same subordinate domain are handled by the respective domain manager, and need not pass through the master domain manager.

An important feature of a data processing system is the tolerance to faults, i.e., the ability of the system to continue more or less normal operation despite the occurrence of hardware or software faults. In a computer network, ensuring an adequate tolerance to faults includes inter alia implementing a message dispatch/routing mechanism adapted to tolerating network faults, like failures of one or more network nodes.

Fault tolerance may be implemented by assigning to some computers in the network the role of backup computers, which take over the responsibilities normally assigned to other computers of the network, in case such other computers face a failure. In particular, in a network structured in domains, the backup computers have to take over the responsibility of dispatching/routing messages to the proper destinations.

For example, in the above-mentioned example of the workload scheduler network, fault tolerance at the level of the master domain may be achieved by assigning to a computer of the network the role of backup of the master domain manager (the backup computer may for example be a domain manager of a subordinate domain subordinate to the master domain, or another computer in the master domain); similarly, in subordinate domains, one computer of the domain may be assigned the role of backup of the respective domain manager computer.

In particular, in every domain (being it the master domain or a subordinate domain, at whichever level of the domains hierarchy), or at least in those domains which are considered more critical, a backup computer can be defined, adapted to take over responsibilities of the respective domain manager.

The backup computers need to have at any time available a same level of information as that possessed by the respective domain manager, so that in case the latter faces a failure, the associated backup computer can effectively take over the responsibility and perform the tasks that were intended to be performed by the domain manager. In particular, having a same level of information means being able to reproduce the messages that would have been dispatched/routed by the domain manager, should the latter have not failed. To this purpose, the network may be structured so that every message received by the domain manager, is also received in copy by the associated backup computer.

However, once role of the generic domain manager is taken over by the respective backup computer, the latter needs to determine which of the messages have already been dispatched/routed by the domain manager before experiencing the failure, and which not. In case the computers of the network work in a cluster configuration, or at least some kind of storage (e.g., disk) sharing exist, the above goal can be achieved for example by having the domain manager exploiting a persistent queue to store outgoing messages: once the domain manager dispatches a generic message, that message is removed from the queue; provided that the backup computer can access the queue, it can at any time determine which messages are still to be dispatched. However, if the computers do not work in cluster configuration, or no possibility of disk sharing exists, the backup computer cannot know which messages have already been dispatched by the domain manager before failure.

### SUMMARY OF THE INVENTION

The Applicant has tackled the problem of improving current implementations of fault tolerant computer networks.

According to an aspect of the present invention, a method as set forth in appended claim 1 is provided.

The method comprises:

having a message originator computer, upon originating a generic messages for a destination computer, labelling the message by means of a message identifier adapted to uniquely identify the originated message;

having the message destination computer, upon receipt of a generic message, record the respective message identifier in a list of identifiers of received messages;

in case a backup computer takes over the role of a manager computer provided for managing the distribution of messages from the message sender to message destination computers, having the backup computer retrieve, from the message destination computer, the list of identifiers of received messages; and

based on the retrieved list of identifiers of received messages, having the backup computer dispatch to the destination computer messages directed thereto that have been received by the backup computer but that were not received by the destination computer.

Thanks to the method according to the present invention, it is ensured that, in case of failure of the manager computer, the messages that were still not delivered to the message destination computers are delivered thereto, in the correct chronological order and without any message repetition.

### BRIEF DESCRIPTION OF THE DRAWINGS

The features and advantages of the present invention will be made apparent by the following detailed description of an embodiment thereof, provided merely by way of a non-limitative example, description that will be conducted making reference to the attached drawings, wherein:

FIG. 1A schematically depicts a data processing system, particularly a computer network in which a method according to an embodiment of the present invention is applicable;

FIG. 1B shows the main functional blocks of a generic computer of the computer network;

FIG. 2 shows the computer network of FIG. 1 from a logical architecture viewpoint;

FIG. 3 schematically depicts the network of FIG. 2, in case a domain manager thereof experiences a failure;

FIG. 4 schematically shows, in terms of functional blocks representative of the main software components, a generic node of the network not being a domain manager node nor a backup node, in an embodiment of the present invention;

FIG. 5 schematically shows, in terms of functional blocks representative of the main software components, a backup node of the network of FIGS. 2 and 3, in an embodiment of the present invention;

FIG. 6 is a schematic, simplified flowchart of the actions performed by the generic node of the network not being a domain manager node nor a backup node, in an embodiment of the present invention; and

FIG. 7 is a schematic, simplified flowchart of the actions performed by the generic backup node of the network, in an embodiment of the present invention.

### DETAILED DESCRIPTION OF THE PREFERRED EMBODIMENT(S)

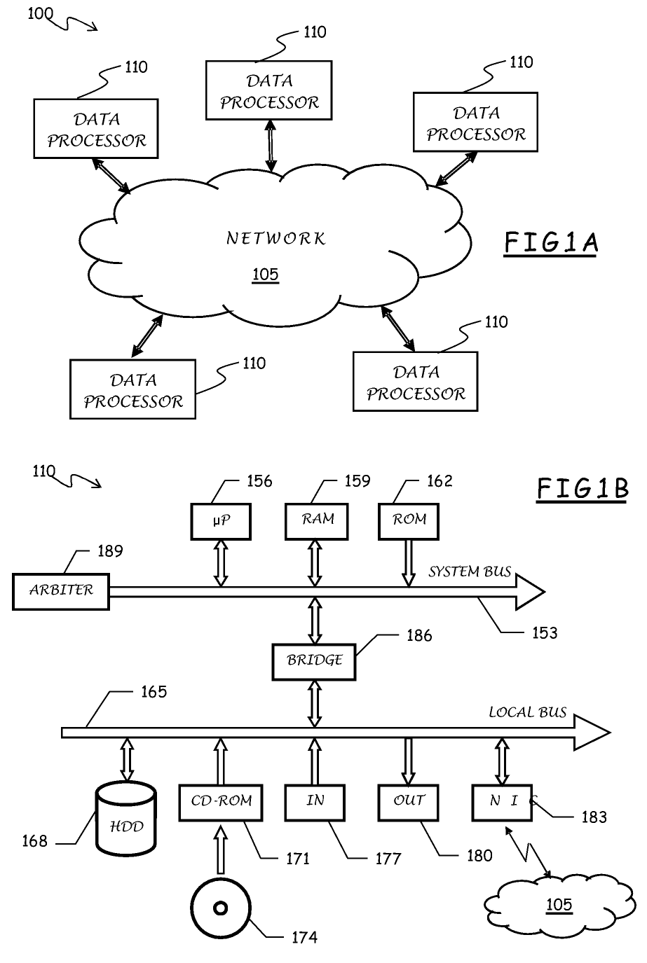

With reference in particular to FIG. 1A, a schematic block diagram of an exemplary data processing system 100 is illustrated, in which a method according to an embodiment of the present invention can be applied.

In particular, the exemplary data processing system 100 has a distributed architecture, based on a data communications network 105, which may typically consists of an Ethernet LAN (Local Area Network), a WAN (Wide Area Network), or the Internet. The data processing system 100 may for example be the information infrastructure, i.e., the so-called “production environment” of a SOHO (Small Office/Home Office environment) or of an enterprise, a corporation, a government agency or the like.

In the data processing system 100, several data processors 110, for example personal computers or workstations (hereinafter, for the sake of conciseness, simply referred to as “computers”), are connected to the data communications network 105 in a computer network configuration.

As shown in FIG. 1B, a generic computer 110 of the data processing system 100 is comprised of several units that are connected in parallel to a system bus 153. In detail, one or more CPUs, e.g. microprocessors (μP) 156 control the operation of the computer 110; a RAM 159 is directly used as a working memory by the microprocessors 156, and a ROM 162 non-volatily stores the basic code for a bootstrap of the computer 110, and possible other persistent data. Peripheral units are connected (by means of respective interfaces) to a local bus 165. Particularly, mass storage devices comprise a hard disk 168 and a CD-ROM/DVD-ROM drive 171 for reading CD-ROMs/DVD-ROMs 174. Moreover, the computer 110 typically includes input devices 177, for example a keyboard and a mouse, and output devices 180, such as a display device (monitor) and a printer. A Network Interface Card (NIC) 183 is used to connect the computer 110 to the network 105. A bridge unit 186 interfaces the system bus 153 with the local bus 165. Each microprocessor 156 and the bridge unit 186 can operate as master agents requesting an access to the system bus 153 for transmitting information; an arbiter 189 manages the granting of the access to the system bus 153.

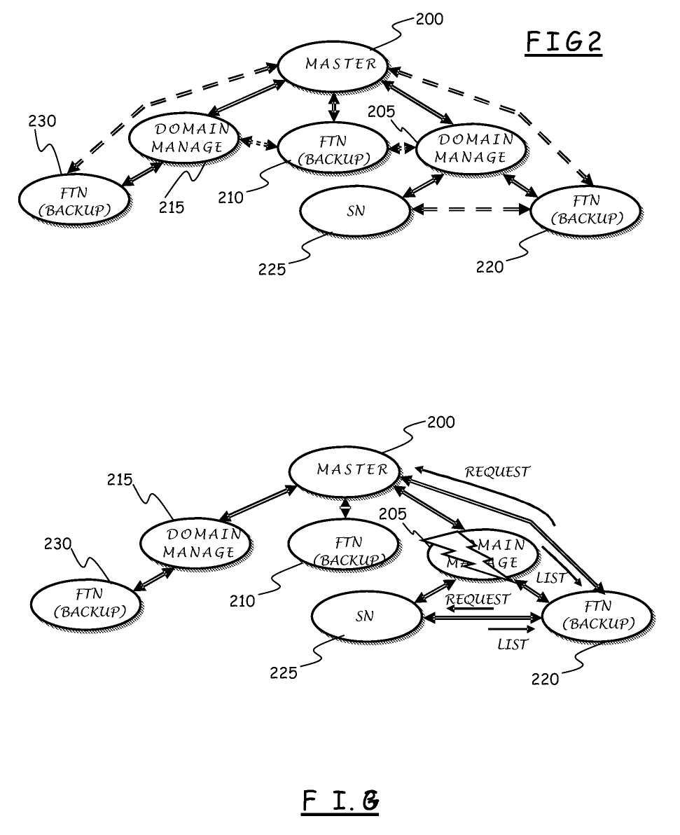

Merely by way of example (but this is not to be construed as a limitation of the present invention, which has more general applicability), a workload scheduling tool like the previously cited Tivoli Workload Scheduler by IBM Corporation, is installed in the computers 110 of the data processing system 100; once installed, the Tivoli Workload Scheduler forms a workload scheduler network. Referring to FIG. 2, the computer network of FIG. 1 is depicted from a logical architecture viewpoint, with the computers 110 represented as network nodes, and interconnection lines (depicted as solid-line arrows in the drawing) representing logical connections between the different network nodes, i.e. communication links that allow the network nodes to communicate, particularly exchange messages. The computer network is in particular a multi-domain network, arranged in a hierarchy of network domains, comprising a master domain and a plurality (in the shown example, two) subordinate domains. The master domain is the topmost domain of the hierarchical tree of domains, and includes a master domain manager network node (hereinafter, shortly, “master domain manager”) 200 forming the network's management hub, for example the management hub of the workload scheduler network. The master domain manager 200 communicates (exchanges messages) with the network nodes in its domain, like the three nodes 205, 210 and 215 in the shown example; the node 210 is a “leaf” node (i.e., a network node having no further hierarchical levels thereunder), whereas the nodes 205 and 215 are subordinate domain manager network nodes (hereinafter, shortly, “subordinate domain managers”) which manage respective subordinate domains, subordinate to the master domain. The subordinate domain managed by the subordinate domain manager 205 includes in the example two leaf nodes 220 and 225, whereas the subordinate domain managed by the subordinate domain manager 215 includes in the example the single leaf node 230. It is pointed out that the network architecture herein considered and depicted in the drawings is merely an example, and not limitative to the present invention; further hierarchical levels might for example exist, or the network may have only one level (the master domain level).

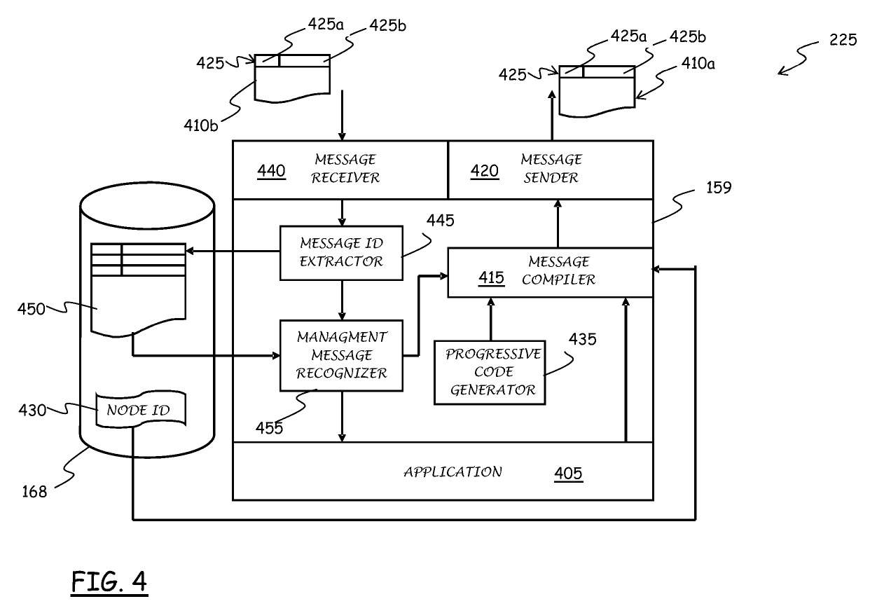

The network is fault-tolerant. In particular, in an embodiment of the present invention, every domain (being it the master domain or a subordinate domain, at whichever level of the domains' tree hierarchy), a backup node is defined, adapted to take over responsibilities of the respective domain manager in case the latter experiences a failure. In particular, in the example shown in the drawing, the leaf node 210 in the master domain is a backup master, acting as the backup of the master domain manager 200, and the leaf nodes 220 and 230 in the subordinate domains act as backups of the respective subordinate domain managers 205 and 215, respectively. Dashed line arrows in the drawing represent backup logical connections between the network nodes, that are provided in addition to the normal connections, so as to enable the backup nodes perform their function of backup of the respective (master or subordinate) domain managers, particularly to communicate with the same nodes of the network with which the respective domain managers communicate. For example, as depicted schematically in FIG. 3, in case the subordinate domain manager 205 experiences a failure, the backup node 220 takes over the responsibilities of the domain manager 205, the backup connections are activated, and the backup node 220 starts managing the communications with the other nodes of its subordinate domain (in the example, the node 225), and with the master domain manager 200. In particular, as will be described in the following, the backup node ensures the dispatch of the messages to the intended destinations, without alterating the original message chronological sequence, and avoiding message repetitions. It is pointed out that, in alternative embodiments of the invention, only some network domains, not necessarily all of them, may be rendered fault-tolerant; thus, backup nodes may be defined only in those domains that are chosen to be rendered fault-tolerant.

Referring again to the Tivoli Workload Scheduler example, without entering into excessive details, the master domain manager 200 is the network node that contains centralized database files used to document scheduling objects, that creates production plans at the beginning of each day, and that performs all logging and reporting operations for the network. The backup master 210 is a network node capable of taking over responsibilities of the master domain manager 200 for automatic workload recovery. A generic network node may be fault-tolerant or not. A fault-tolerant node (“FTN” in the drawings, or “Fault-Tolerant Agent”—FTA), is a computer capable of resolving local dependencies and of launching its jobs even in absence of the domain manager; a backup node is typically a fault-tolerant node. A node that is not fault-tolerant is also referred to as “standard node” (“SN” in the drawings, or “Standard Agent”—SA).

Before the start of each working day, the master domain manager 200 creates a production control file, and the workload scheduler is then restarted in the workload scheduler network. The master domain manager 200 sends a copy of the production control file to each of the fault-tolerant nodes directly linked thereto, in the example the leaf node 210 and the two subordinate domain managers 205 and 215. This process is iterated: the domain managers 205 and 215 send a copy of the received production control file to the respective subordinate domain managers (if any) and fault-tolerant nodes directly linked thereto, in the example the leaf nodes 220, 225 and 230. Once the workload scheduling network has been started, scheduling messages like job starts and completions are passed from the agents (SAs or FTAs) to their respective domain managers, and the domain managers route the messages up to the master domain manager; the latter broadcasts messages through the hierarchical tree (through the domain managers down to the leaf nodes) to update the copies of the production control file held by the subordinate domain managers and leaf nodes (particularly, the FTAs).

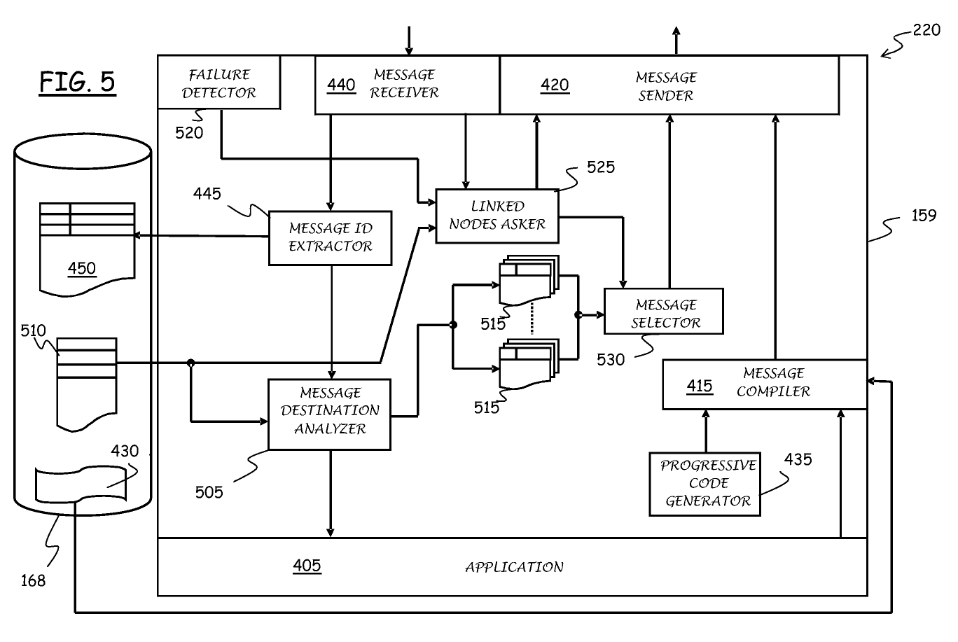

Referring to FIG. 4, there is schematically depicted a partial content of the working memory 159 of the generic node of the network which is not a domain manager nor a backup node, particularly a standard node or standard agent, like for example the node 225 of FIGS. 2 and 3, in an embodiment of the present invention; in particular, functional blocks are meant to correspond to software modules that run in the computer (an operating system usually running in every computer is not explicitly depicted). Block 405 represents an application software running in the computer for performing the intended tasks; for example, in the exemplary case of the Tivoli Workload Scheduler network, the application software 405 may include the workload scheduler engine, which is installed and runs on every computer of the workload scheduler network; it is pointed out that the specific type of application software is not limitative for the present invention: in particular, the application software may have either a single-process or a multi-process architecture. When in operation, the application software 405 needs to communicate with other network nodes, particularly sending and receiving messages; in the drawing, reference numerals 410a and 410b respectively identify a generic outgoing message, addressed for example to the master domain manager 200 (to which the message is routed by the domain manager 205), and an incoming message, for example issued by the master domain manager 200 and received from the domain manager 205. A message compiler module 415 receives from the application software 405 the message body, and prepares the message to be sent (according to predetermined communications protocols, per-se not critical for the present invention). The prepared message is passed to a message sender module 420, which manages the dispatch of the message 410a (handling in particular the lower-level aspects of the message transmission over the data communications network 105).

According to an embodiment of the present invention, the message compiler module 415 is adapted to insert in the message to be sent 410a a message identifier or message tag 425, adapted to univocally identify the generic message issued by the network node 225. In particular, the message identifier 425 includes a first identifier field 425a and a second identifier field 425b; the first identifier field 425a is adapted to univocally identify, among all the nodes of the network, the network node 225 that has generated the message; the second identifier field 425b is in turn adapted to univocally identify that message among all the messages generated by that network node. In an embodiment of the present invention, the first identifier field 425a includes for example a code corresponding to the name 430 (“NODE ID” in the drawing) assigned to the computer 225 for identifying it in the network, stored for example (in a file stored) in the computer's hard disk 168. The second identifier field 425b is for example a code, e.g. a progressive integer, which in FIG. 4 is meant to be generated by a progressive code generator 435, for example a counter. When the message compiler module 415 receives a message body from the application software module 405, it retrieves the network node identifier 430, and invokes the progressive code generator 435, which generates a new code; using the network node identifier 430 and the progressive code generated by the progressive code generator 435, the message compiler module 415 builds the message identifier 425, and puts it in the prepared message. A mechanism is preferably implemented which is adapted to save the last progressive code generated by the progressive code generator 435 on a non-volatile storage, e.g. the hard disk, when, for example, the computer is shut down, or the process is terminated.

Similarly to the message sender module 420, a message receiver module 440 manages the receipt of incoming messages 410b (handling in particular the lower-level aspects of the message receipt from the data communications network 105). The received message is passed to a message identifier extractor module 445, which is adapted to parse the received message and to extract the respective message identifier 425. The message identifier extractor module 445 puts the extracted message identifier 425, extracted from the received message, into a message identifier table 450, which is adapted to contain the message identifiers of the messages received by the network node 225. The message identifier table 450 may be stored in the computer's hard disk 168, as in the shown example, or it may be saved in a portion of the working memory 159; in this latter case, a mechanism may be implemented adapted to save the message identifier table on the hard disk when, for example, the computer is shut down, or the process is terminated. The message identifier table 450 may be adapted to store a prescribed, maximum number of message identifiers, and implement a “first-in, first-out” policy, for freeing space when full; in this way, the identifiers of obsolete messages are removed for freeing space. In particular, the message identifier table 450 may be adapted to retain the identifier(s) of the last message(s) which the node 225 received from each other network node. From the message identifier extractor module 445, the message is passed to a management message recognizor module 455, adapted to ascertain whether the received message is a backup management message; for the purposes of the present description, by backup management message there is in particular meant a message not intended to be used by the application software 405, but instead relating to the management of the network fault tolerance in case of failure of a network node. If the received message is not a backup management message, the management message recognizor module 455 passes it to the application software module 405; otherwise, i.e. in case the received message is recognized to be a management message, the management message recognizor module 455 is adapted to retrieve the list of message identifiers contained in the message identifiers table 450, and to pass it to the message compiler module 415, for being sent to the competent backup domain manager, as will be explained later on in the present description. Similarly to the generic message issued by the application software 405, the message compiler module 415 inserts the message identifier 425, and the message is sent by the message sender module 420. It is observed that, in alternative embodiments of the invention, it may be foreseen that the message compiler module, in addition to insert the message identifier in the generic message to be sent, also logs the message identifier in the table 450: in this case, the table will contain not only the message identifiers of the received messages, but also those of the messages issued by the network node 225.

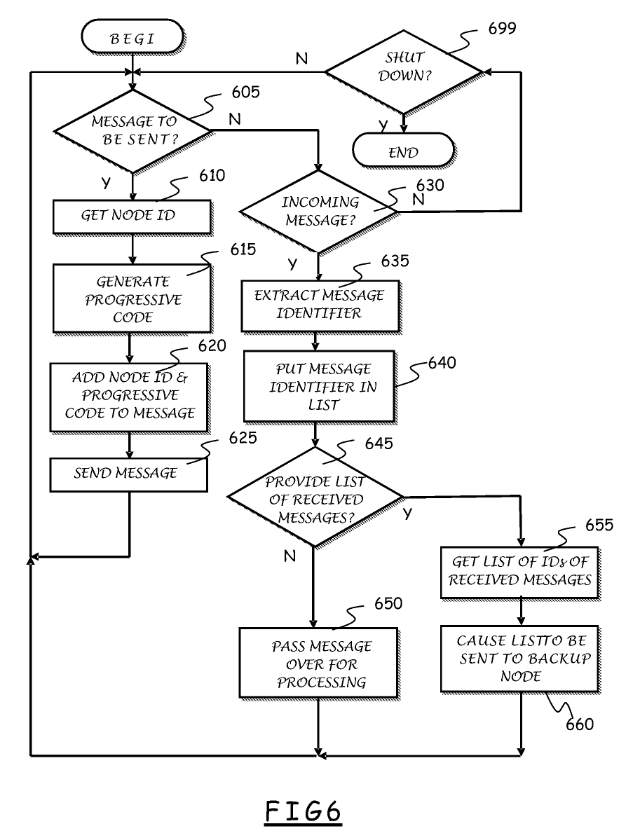

Similarly to FIG. 4, FIG. 5 schematically depicts a partial content of the working memory 159 of the generic backup node of the network, like for example the node 220 of FIGS. 2 and 4, in an embodiment of the present invention. In particular, there are schematically shown the application software 405, for example, in the exemplary case of the Tivoli Workload Scheduler network, the workload scheduler engine installed and running in the computer for performing the intended tasks; the message compiler module 415, adapted to insert into the generic message to be sent the message identifier 425 that univocally identifies the message, by including for example the code corresponding to the network node name (NODE ID) 430, and a progressive code, generated by the progressive code generator 435; the message sender module 420; the message receiver module 440; and the message identifier extractor module 445, adapted to put the extracted message identifiers 425 into the message identifier table 450. A message destination analyzer module 505 is further provided, adapted to analyze the received message so as to determine which is the message destination, i.e., to which network node the message is addressed. The message destination analyzer module 505 exploits a destinations table 510, stored for example on the computer's hard disk 168, or alternatively in the working memory 159, which destinations table contains the addresses of all the network nodes to which the node 220 is linked; in particular, the destinations table 510 contains the addresses of all the network nodes (other than the node 220) to which the domain manager 205 in respect of which the node 220 acts as a backup is linked (in the shown example, the master domain manager 200, and the leaf node 225). In case the message destination analyzer module 505 ascertains that the received message is addressed to the node 220, it passes the message to the application software 405. Differently, the message destination analyzer module 505 does not pass the message to the application software, rather puts the received message in a respective one of a plurality of message queues 515 held by the node 220, one message queue 515 in respect of each linked network node (the message queues may be stored in the computer's hard disk 168, or they may be saved in the working memory 159, as in the shown example). A failure detector module 520, adapted for example to receive by a system manager operator an instruction for the node 220 to take over the role of the respective domain manager 205, or possibly capable of automatically detecting a failure condition in the domain manager 205 of which the node is a backup, controls a linked nodes asker module 525, adapted to send to each of the linked nodes (as specified in the destinations table 510) a request for retrieving the message identifiers list contained in the respective message identifiers table 450. Based on the retrieved message identifiers lists, a message selector 530 is adapted to select, from the message queue 515 of the generic linked node, the messages that still wait to be received by that network node, and to cause them to be sent to the proper destination.

The structure of the generic domain manager, like for example the master domain manager 200 and the subordinate domain managers 205 and 215, is not explicitly shown, however, similarly to the backup node just described, the generic domain manager manages the dispatch/routing of the messages to the intended destinations, i.e. to the network nodes linked thereto. According to an embodiment of the present invention, also the generic domain manager, like the generic leaf node and backup node, implements a mechanism for labelling all the messages it generates, particularly the message compiler module 415, adapted to insert into the generic message to be sent the message identifier 425 univocally identify the message, by including the network node name 430, and a progressive code, generated by the progressive code generator 435.

The operation of the fault-tolerant computer network will be hereinafter described, according to an embodiment of the invention.

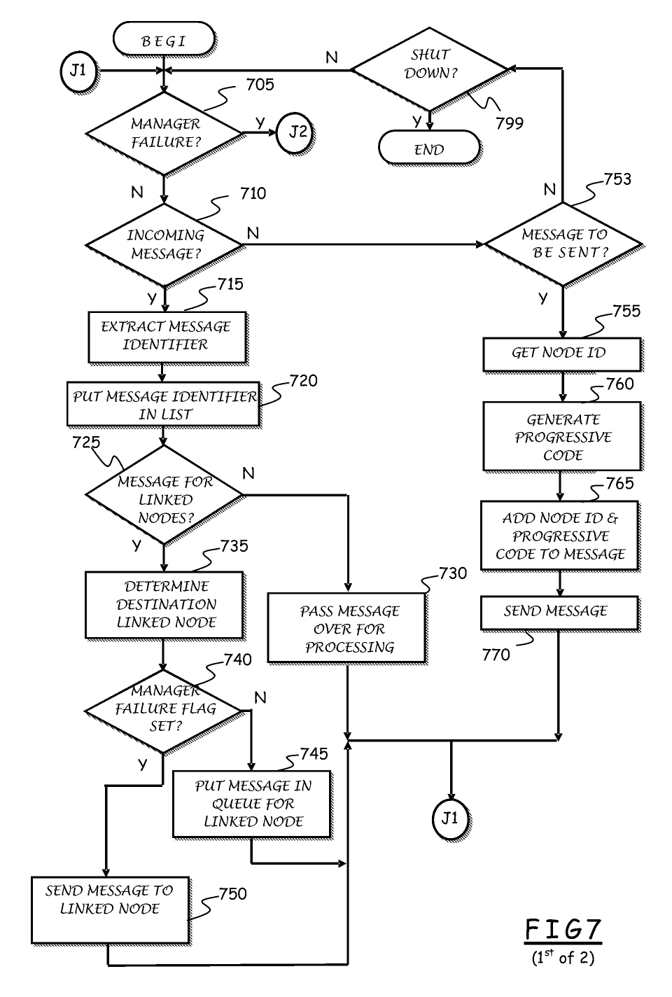

In particular, the schematic and simplified flowchart of FIG. 6 depicts the actions performed by the generic leaf node which is not a domain manager nor a backup thereof, for example the node 225. It is pointed out that only the main actions relevant to the understanding of the invention embodiment being described will be discussed, and in particular all the actions pertaining to the tasks managed by the application software are not described, being not relevant to the understanding of the invention.

The node 225 periodically checks whether there are messages (generated by the application software 405) waiting to be sent (decision block 605).

In the affirmative case (exit branch Y of decision block 605), the message compiler module 415 gets the identifier of the network node (NODE ID) 430 (block 610), asks the progressive code generator 435 to generate a new progressive code (block 615), uses the network node identifier and the generated progressive code to compose the message identifier 425, and adds the message identifier 425 to the message to be sent (block 620); the composed message is then sent (block 625), and the operation flow jumps back to the beginning.

If no message waits to be sent (exit branch N of decision block 605), the node 225 checks whether there are incoming messages (decision block 630).

In the affirmative case (exit branch Y of decision block 630), the message identifier extractor 445 extracts the message identifier 425 from the received message 410b (block 635), and puts the extracted message identifier 420 into the message identifiers table 450 (block 640).

The management message recognizor module 455 then checks whether the received message is a management message, requesting the node 225 to provide the content of the respective received message identifiers table 450 (decision block 645), or rather a normal message directed to the application software 405.

In the negative case (exit branch N of decision block 645) the message is passed over to the application software 405 for processing (block 650).

In the affirmative case (exit branch Y of decision block 645), the management message recognizor module 455 retrieves the content of the received message identifiers table 450 (block 655), and provides it to the message compiler module 415 (block 660), which will then prepare a message (or, possibly, more messages) to be sent to the backup node 220 (in a way similar to that described above). The operation flow then jumps back to the beginning.

Back to decision block 630, if no incoming messages are waiting to be served (exit branch N), the operation flow jumps back to the beginning, unless the computer is shut down (decision block 699, exit branch Y), in which case the operations end.

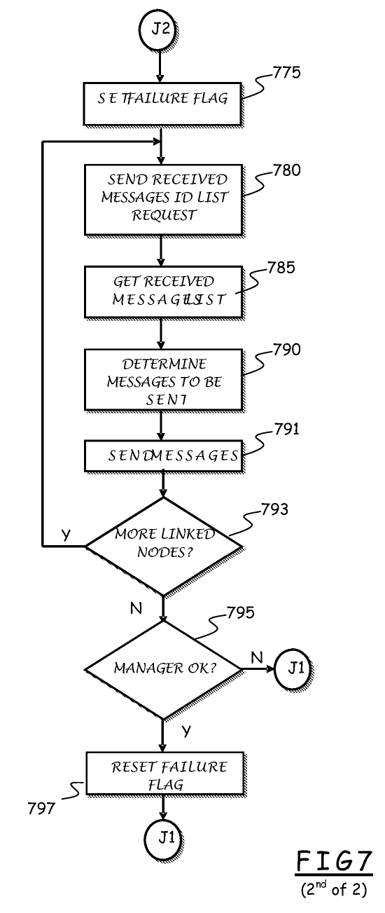

FIG. 7 depicts the actions performed by the generic backup node, like for example the backup node 220; also in this case, only the main actions relevant to the understanding of the invention embodiment being described will be discussed, and in particular all the actions pertaining to the tasks managed by the application software are not described, being not relevant to the understanding of the invention.

The backup node 220 periodically checks whether the respective domain manager in respect of which it acts as a backup, in the shown example the domain manager 205, is experiencing a failure (decision block 705); for example, the failure detector module 520 may check whether a system manager operator has instructed the backup node 220 to take over the role of the domain manager.

In the negative case (exit branch N of decision block 705), the backup node 220 checks whether there are incoming messages waiting to be served (decision block 710). It is pointed out that the generic backup node receives a copy of every message sent by the respective domain manager to the nodes of its domain, as well as a copy of every message sent to the respective domain manager by the nodes (other than the backup node) in the domain. In other words, the backup node is aware of all the message traffic in the domain to which it belongs.

In the affirmative case (exit branch Y of decision block 710, the message identifier extractor 445 extracts the message identifier 425 from the received message (block 715), and puts the extracted message identifier 425 into the message identifiers table 450 (block 720).

The message destination analyzer module 505 then checks whether the message is addressed to one of the linked nodes (i.e. the domain manager, or the other nodes of the domain) (decision block 725).

In the negative case (exit branch N of decision block 725), i.e., in case the incoming message is addressed to the backup node, the message is passed over to the application software 405 for processing (block 730); the operation flow then jumps back to the beginning (connector J1).

If instead the message is ascertained to be addressed to one of the linked nodes, i.e. to one of the network nodes linked to the corresponding domain manager (exit branch Y of decision block 725, the message destination analyzer 505 determines which is the destination linked node (block 735). If the domain manager 205 in respect of which the backup node 220 acts as a backup is not facing a failure (exit branch N of decision block 740, the message is simply put into the proper message queue 515 (block 745); no further action is undertaken, and the operation flow jumps back to the beginning (connector J1): in fact, in case of normal operation, it is the domain manager 205 that is in charge of the task of dispatching/routing the messages to the proper destinations. If, on the contrary, the domain manager is currently facing a failure (a condition signaled for example by a failure flag, set when the failure detector module 520 detects a domain manager failure condition—exit branch Y of decision block 740), the backup node, in addition to putting the message in the proper message queue, also dispatches/routes the message to the proper destination (block 750).

In case no incoming message waits to be processed (exit branch N of decision block 710), it is ascertained whether there are messages (generated by the application software 405 waiting to be sent (decision block 753).

In the affirmative case (exit branch Y of decision block 753), similarly to what described in the foregoing in connection with the leaf node 225, the message compiler module 415 gets the node's ID 430 (block 755), asks the progressive code generator 435 to generate a new progressive code (block 760) composes the message identifier 425 with the network node identifier and the generated progressive code, and adds the message identifier 425 to the message to be sent (block 765); the composed message is then sent (block 770), and the operation flow jumps back to the beginning (connector J1). Also in this case, alternative embodiments of the present invention may foresee that the message compiler module 415 logs the message identifier into the table 450.

If instead there are no messages waiting to be sent (exit branch N of decision block 753), the operation flow jumps back to the beginning, unless for example a shut down takes place (decision block 799, exit branch Y).

Actions similar to those up to now described are similarly performed by the generic domain manager, like the master domain manager 200 and the domain managers 205 and 215 which, in addition, unconditionally dispatches the received messages to the intended destinations.

Let now the case be considered of the domain manager 205 experiencing a failure: when the (failure detector 520 of the) backup node 220 detects this, for example receiving an instruction by a system manager operator (exit branch Y of decision block 705, and connector J2, the backup node 220 has to take over the responsibilities of the failed domain manager 205. The failure detector 520 sets a failure flag (block 775); as described in the foregoing, the failure flag is exploited by the backup node 220 for deciding whether a generic incoming message addressed to one of the linked nodes has to be dispatched to the intended destination, or simply put in the respective message queue 515 (decision block 745). Then, based on the destinations table 510, for the generic one of the linked network nodes (i.e., in the considered example, for the leaf node 225 and the master domain manager 200, the (linked node asker 525 of the) backup node 220 requests the content of the respective received message identifiers table 450 (block 780). Once the list of received message identifiers has been retrieved from that linked node (block 785), the (message selector 530 of the) backup node 220 selects from the message queue 515 corresponding to that linked node the messages that, based on the retrieved list of received message identifiers, result not to have been sent to that network node (block 790); for example, before its failure the domain manager 205 may have received messages addressed to one of the network nodes in its domain, but the domain manager 205 did not have enough time to route these messages to the proper destination before incurring the failure. For example, let it be assumed that the retrieved list contains the following message identifiers:

| NODE ID | PROGRESSIVE CODE |
|---|---|
| Ida | 100 |
| Idb | 35 |
| Ida | 99 |
| . . . | . . . |

and let it be assumed that, in the message queue 515 in respect of the network node under consideration, there are the messages labelled by the following identifiers:

IDa, 103
IDa, 102
IDb, 35
IDa, 101
. . .

The message selector 530 can thus determine that the messages from the node with identifier Ida and numbered 101, 102 and 103 were not received by the network node under consideration (which received messages up to the one numbered 100), whereas all the messages from the network node with identifier Idb have been received.

The (message selector 530 of the) backup node 220 accordingly causes the selected messages to be sent to the proper destination node (block 791). In particular, it is possible to ensure that the messages are sent to the intended destination node in the proper chronological sequence: if a generic node issues two messages in sequence, it is ensured that the two messages are received as well in the correct sequence; this is a feature that may be a prerequisite for the correct operation of the data processing system. These operations are repeated for all the linked nodes (decision block 793), as specified in the destinations table 510. Before jumping back to the beginning (connector J1), it is ascertained whether the functionality of the domain manager has in the meanwhile been reestablished (decision block 795), in which case the failure flag is reset (block 797).

Thanks to the described solution, it is ensured that, in case of failure of a domain manager, messages which was sent, but not received (for example, messages that waited to be routed) to subordinate network nodes do not get lost. The backup node is put in condition to know exactly which messages need to be sent to each of the linked network nodes, avoiding any dispatch duplication or delay, and to send the messages in the proper chronological order.

It is also possible to define different categories of messages, for example having different criticality, and to manage in the way previously described only those messages that are considered more critical for the network operation.

The implementation of the present invention has been described making reference to an exemplary embodiment thereof, however those skilled in the art will be able to envisage modifications to the described embodiment, as well as to devise different embodiments, without however departing from the scope of the invention as defined in the appended claims.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of the present description, a computer-usable or computer-readable medium can be any apparatus, device or element that can contain, store, communicate, propagate, or transport the program for use by or in connection with the computer or instruction execution system.

The medium can be an electronic, magnetic, optical, electromagnetic, infrared, or semiconductor storage medium, network or propagation medium. Examples of a storage medium include a semiconductor memory, fixed storage disk, moveable floppy disk, magnetic tape, and an optical disk. Current examples of optical disks include compact disk—read only memory (CD-ROM), compact disk—read/write (CD-R/W) and digital versatile disk (DVD). Examples of a propagation medium include wires, optical fibers, and wireless transmission.

The invention can be applied in a data processing system having a different architecture or based on equivalent elements; each computer can have another structure or it can be replaced with any data processing entity (such as a PDA, a mobile phone, and the like).

1. The system as recited in claim 7 further comprising: computer, a method comprising:
means for having the message originator computer, upon originating a generic message, labelling the message by means of a message identifier, the message identifier being adapted to uniquely identify the originated message;
means for having the message destination computer, upon receipt of a generic message, record the respective message identifier in a list of identifiers of received messages;
means responsive to the backup computer taking over the role of the manager computer for having the backup computer retrieve, from the message destination computer, the list of identifiers of received messages; and
means responsive to the retrieved list of identifiers of received messages for having the backup computer dispatch to the destination computer messages directed thereto that have been received by the backup computer but not received by the destination computer.

2. The system according to claim 1, in which the message identifier is adapted to uniquely identify the message originator computer and the originated message among all the messages originated by the message originator computer.

3. The system according to claim 2, in which the message identifier includes a first identifier part, adapted to uniquely identify the message originator computer, and a second identifier part, adapted to uniquely identify the generic originated message among the messages originated by the message originator computer.

4. The system according to claim 3, in which said first identifier part includes an identifier code adapted to identify the message originator computer in the data processing system.

5. The system according to claim 4, in which said second identifier part includes a progressive code generated by the message originator computer in respect of the originated message.

6. The system according to claim 5, in which said having the backup computer dispatch to the destination computer messages directed thereto that have been received by the backup computer but that were not received by the destination computer includes having the backup computer explot the progressive code for dispatching the messages respecting a chronological order of generation of the messages by the message originator computer.

7. A distributed data processing system comprising a plurality of computers in communications relationship, said plurality of computers including:
at least one message originator computer and at least one message destination computer, wherein the message originator computer is adapted to originate messages to be delivered to the message destination computer, the message originator computer being further adapted to label each originated message by means of a message identifier adapted to uniquely identify the message, and the message destination computer being adapted, upon receipt of a generic message, to record the respective message identifier in a list of identifiers of received messages;
at least one manager computer responsible of managing communications between the computers of said plurality, wherein the manager computer is adapted to receive the messages originated by the originator computer and to dispatch the messages to the destination computer; and
at least one backup computer adapted to take over the role of the manager computer in case of failure thereof, wherein the backup computer is adapted to receive the messages originated by the originator computer and, in case of failure of the manager computer, to retrieve the list of identifiers of received messages from the message destination computer and, based on the retrieved list, to dispatch to the destination computer messages that have been received by the backup computer but not by the destination computer.

8. A method comprising:
having a first computer of a distributed data processing system originate a message to be delivered to a second computer of the data processing system;
having the first computer labelling the originated message by a message identifier adapted to uniquely identify the message.

9. The method according to claim 8, in which said labelling the originated message by a message identifier comprises including in the originated message a first identifier part, adapted to uniquely identify the message originator computer, and a second identifier part, adapted to uniquely identify the generic originated message among the messages originated by the message originator computer.

10. The method according to claim 9, in which said first identifier part includes an identifier code adapted to identify the message originator computer in the data processing system, and said second identifier part includes a progressive code generated by the message originator computer in respect of the originated message.

11. A computer program product comprising a computer usable medium having a computer readable program embodied in said medium, wherein the computer readable program when executed on a computer causes the computer to:
originate a message to be delivered to a recipient computer;
label the originated message by a message identifier adapted to uniquely identify the message.

12. (canceled)

13. The method comprising according to claim 8, further the steps of:
having a computer of a distributed data processing system receive a message, wherein the message is identified by a message identifier adapted to uniquely identify the message;
having the computer recording the message identifier of the received message in a list of identifiers of received messages;
upon request, having the computer providing the list of received message identifiers.

14. The computer program product according to claim 11, wherein the computer readable program when executed on a computer further causes the computer to:
receive a message identified by a message identifier adapted to uniquely identify the message;
record the message identifier of the received message in a list of identifiers of received messages identifiers;
upon request, providing the list of received message identifiers.

15. (canceled)

16. The method according to in claim 8, wherein the method is practiced in a distributed data processing system comprising a plurality of computers in communications relationship, at least one manager computer responsible of managing dispatch of messages from a first to a second computers of said plurality, and a backup computer adapted to take over the role of the manager computer in case of failure thereof, wherein the backup computer is adapted to receive the messages originated by the originator computer and, in case of failure of the manager computer, to dispatch the messages to the message destination computer, the method further the steps of comprising:
in case the backup computer takes over the role of the manager computer, having the backup computer retrieve, from the second computer, a list of identifiers of received message , wherein the message identifiers are adapted to uniquely identify the messages; and
based on the retrieved list of received message identifiers, having the backup computer dispatch to the second computer messages that have been received by the backup computer but not by the second computer.

17. The computer program product according to claim 11, wherein the computer readable program when executed on a computer further causes the computer to:
receive a copy of messages directed to at least one message destination computer;
retrieve, from the message destination computer, a list of identifiers of messages received by the message destination computer, wherein the message identifiers are adapted to uniquely identify the messages; and
based on the retrieved list of received message identifiers, dispatch to the message destination computer messages that have been received by the computer but not by the message destination computer.

18. (canceled)
